(19) United States
(12) Patent Application Publication
(10) Pub. No.: US 2002/0083851 A1
(43) Pub. Date: Jul. 4, 2002

(54) Apparatus for crushing cans

(76) Inventor: Ronnie G. Gragg, Hanceville, AL (US)

Correspondence Address: Richard C. Litman, LITMAN LAW OFFICES, LTD., P.O. Box 15035, Arlington, VA, 22215, US

(21) Appl. No.: 09/750,781

(22) Filed: Jan. 2, 2001

(51) Int. Cl. B30B 1/32

(52) U.S. Cl. 100/902; 100/269.01

(57) ABSTRACT

An apparatus for crushing cans, including a crush chamber, an air control valve, a pneumatic air chamber, a key lockable air supply assembly, and a plurality of air hoses. The crushing mechanism or apparatus includes the air chamber, a guide plate, and a crush plate. The control valve requires that the lid be in closed position in order to activate the apparatus. The housing also includes a removable liner; the liner is generally U-shaped in cross-section and has a curved portion along its upper edge for hanging the liner inside of the crush chamber.

### BACKGROUND OF THE INVENTION

1. Field of the Invention

The present invention generally relates to compacting apparatuses and, more specifically, to can or bottle crushing devices.

2. Description of the Related Art

The United States has seen an unprecedented growth in the area of recycling and treatment or processing of waste products in the past few decades. Most advances in the art have centered around the development of techniques which improve the process of mechanically deforming or compacting trash, such as bottles and cans. However, none of the references herein described presents a crushing apparatus, which is both effective for use and designed to be easily opened for maintenance and cleansing of residual liquid and other matter left behind after the crushing process. For example, U.S. Pat. No. 4,345,508, issued to Cash et al., presents a can crusher which has a pair of pivotal arms responsive to the position of the pistons within an elongated, base mounted tube for denting or creasing and piercing the side of the can prior to the crushing of the can by the piston. The piston is activated with a pivotable handle which engages the piston through apertures in the tube. The pivot arms are mounted to the outside of the tube and are biased toward the axis of the tube into engagement with the side of the piston. As the piston moves towards a can, the protruding portions of the upper ends of the pivot arms are forced away from the axis of the tube, thus forcing the protruding portions on the lower ends of the arms into the side of the can, thereby piercing and denting the can. As the piston crushes the can, the lower protruding portion is pivoted away from the can by the action of a biasing spring. The end of the pivotal handle can be curved to produce off-axis forces on the piston.

U.S. Pat. No. 5,048,413, issued to Deiters, discloses a platform which is supported on uprights on a base and extends over the top of an open top waste receptacle arranged to be supported on the base. The can crushing compartment is on the platform and has a pop board plunger to crush cans in the compartment to a reduced size. The compartment in which the cans are crushed has a bottom opening of restricted size to maintain cans in the compartment prior to crushing but which also allows cans to fall by gravity into the waste receptacle and also between a cover on the crushing compartment. Inlets and outlets are provided on the platform that admit fresh air and that carry away fumes from the waste receptacle.

U.S. Pat. No. 5,325,771, issued to Morris, discusses an oil filter crushing apparatus and method utilizing a housing defining an interior space and a bottom surface. A crushing member is fitted within the housing having a crushing surface and defines a slot opening through the crushing surface. Also provided is a puncturer having a point and movably attached to the crushing member within the slot opening so that the puncturer is behind the crushing surface in a retracted position; at least a portion of the puncturer is forward of the crushing surface in puncturing position.

U.S. Pat. No. 5,337,656, issued to Hollnagle, presents an oil filter crushing apparatus having a crushing frame mounted on a filter platform on which a used oil filter is supported on end for crushing by a ram device having a single ramrod. An air spring actuating device is mounted on the frame and operates on low pressure shop air for a selectively forcing the ram device downwardly to crush the filter against the platform.

U.S. Pat. No. 5,361,690, issued to Hsu, discloses a can crusher for environmental protection which is generally composed of a hydraulic pump to drive a piston, upwardly or downwardly. When the piston is driven downwardly, a plate is driven downwardly to crush a can. A groove is formed at the inner bottom portion to drain any residues left in the can.

U.S. Pat. No. 5,383,397, issued to Battles et al., discusses an oil filter crushing apparatus including a frame which is mounted to a filter platform configured to receive a used oil filter for crushing. An air spring actuated device is secured within the frame, and a ram is secured to a lower end of the air spring. A control valve regulates the flow of the pressurized gas into the air spring which then causes the ram to crush the filter. A safety pneumatic circuit is also provided.

U.S. Pat. No. 5,718,168, issued to Harrington, presents a trash and recycling center having a modular trash receptacle unit and a modular recycling receptacle. The trash receptacle unit has at least two interior compartments and a movable lid. A trash bag cap can be placed in one compartment and used newspapers can be stored in the other compartment. The recycling receptacle unit has a top with a can crusher, an empty can storage area, and a slot for depositing empty cans into the interior of the recycling receptacle. The interior of the recycling receptacles can have multiple shelves or storage drawers or, can have a single storage bin. The recycling receptacle can also have a removable countertop recycling unit.

U.S. Pat. No. 5,778,773, issued to Clark, discusses a can crusher that is attachable to a trash or recycle container. The crusher has a movable vice between which the can to be crushed is placed. An extendible upright handle is manually operated to move the vice and crush the can, which then exits the container via a normally disposed trap door and a protective chute. Two gear racks with lower camming members open the trap door and a protective chute. After the crushing operation is completed, the handle may be manually returned to its original position to close the normally closed trap-door and permit the crushing of additional cans placed in the vise.

U.S. Pat. No. 5,839,350, issued to Mefferd, discloses a press assembly including a hydraulic cylinder assembly having first and second chambers and respective piston and rod assemblies therein. The rod of the second assembly is arranged to enter the first chamber and thereby raise the pressure therein. Initially, fluid flows into the first chamber, forcing the first rod to exert a force on a work object. When a predetermined pressure is reached within the cylinder, fluid is introduced to the second chamber, and causes a second rod to move into the first chamber, which raises or boosts the pressure in the first chamber.

U.S. Pat. No. 5,941,167, issued to Fleming, presents a portable can compactor including a housing and a chamber in the housing sized to accept aluminum beverage cans for compacting. A ram is reciprocally driven in the chamber to compact cans against a front wall or anvil of the chamber. The ram front surface is sloped relative to the anvil to reduce the amount of force needed to compact the cans. A feed control includes a vein which pivots between an open and a closed position in response to movement of the ram to prevent a second can from entering the chamber before the first can exits the chamber. The compactor is operated by a momentary on push button switch. The switch is surrounded by a guard wall which extends around at least a portion of the push button switch. A cut off switch is closed by a removable feed tray when the feed tray is mounted to the compactor housing. The compactor therefore cannot be operated without the feed tray mounted to the housing. A support platform is provided to mount the can compactor over a collection or recycling bin, so that compacted cans and residual fluids will fall into the bin after they are compacted and exit the compactor. The support platform reinforces plastic recycling bins to substantially prevent an upper edge of the bin from bending over in response to the weight of the compactor.

U.S. Pat. No. 5,967,029, issued to Mario, discusses a new automatic aluminum can crusher for compacting aluminum cans for disposal, including an upper housing comprised of a first compartment and a second compartment. The first compartment has an open upper end with a lid hinged thereto. The first compartment also has an opening through the bottom thereof. A crushing mechanism is disposed within the upper housing. An activation system is disposed interior of the upper housing and is in communication with the crushing mechanism.

German patent No. 2,326,725 shows a refuse comminuter and compactor, which processes refuge from households, restaurants or hospitals. And finally, French patent No. 2,346,147 shows a can crushing machine with a liquid collection facility. The machine has a pneumatic cylinders with crushing jaws above a delivery chute.

None of the above inventions and patents, taken either singularly or in combination, is seen to describe the instant invention as claimed. Thus a bottle recycling apparatus solving the aforementioned problems is desired.

### SUMMARY OF THE INVENTION

The apparatus for crushing cans provides the user with an, environmentally sound, convenient, and easy way to compact cans, bottles, or other items. The apparatus principally includes an air control valve, a pneumatic air chamber, a key lockable air supply assembly, a plurality of air hoses, and a crushing chamber having a housing and a lid. Pressurized air is supplied to the air control valve through an air supply hose. The air control valve is actuated by movement of the lid of the apparatus. The lid is connected to the air control valve by a linkage. The control valve requires that the lid be in closed position in order for pressurized air to flow into the air chamber to initiate the crushing function of the apparatus. After the air chamber receives pressure from the air valve through a primary air hose, excess air is vented through the exhaust line.

The housing of the crushing chamber principally includes a pair of vertically disposed channel irons, each iron having a notch at its lower extent dimensioned for receiving therethrough the wheel of roller. Underlying the vertically disposed channel irons is a horizontally disposed, bottom channel iron, which holds the two vertical channel irons in spaced-apart relationship in order to define a crushing space therebetween. The horizontally disposed channel iron has a generally rectangular-shaped opening for allowing cans which have been crushed to fall therethrough for later collection and disposal.

The crushing mechanism or apparatus includes the pneumatic air chamber, a guide plate, and crush plate. The crush plate is a generally rectangular metallic member having a pair of spacers located on the rear side thereof for holding the guide plate in spaced-apart relationship to the rear channel iron. The guide plate also serves as a support for the piston which is slidably movable through an aperture centrally disposed through the guide plate. Collinear with the aperture is a metallic tube member for helping to guide the piston and keep it in place. The end of the piston is insertably received by a nut fixedly attached to the central portion of the crush plate.

The crush plate also has an aperture disposed adjacent the mid-portion of its lower end. The aperture is dimensioned for receiving a pin mounted adjacent the lower end of the guide plate, the pin being normally disposed to the guide plate front surface. The pin is reciprocally movable through the aperture and dislodges or pushes crushed objects through the opening.

The air chamber is pneumatically actuated and includes an exterior housing, a piston assembly, and a diaphragm. The exterior housing includes first and second generally bowl-shaped shells which together enclose the diaphragm and piston assembly and are held together by a belt. The diaphragm is held in place between the first and second shells, the belt wrapping around and enclosing the flanged free edges of the first and second shells to hold them tightly together.

The piston assembly is made up by a generally circular, metallic plate held in frictional abutment to the diaphragm by a spring located between the metallic plate and the second housing shell. The piston is normally and centrally disposed on one side of the guide plate and acts to urge the crush plate against an object to be crushed. Air flows into the air chamber from the air control valve through the air chamber hose, causing the diaphragm to move against the circular plate, pushing the piston. The housing also includes a removable liner; the liner is generally U-shaped in cross-section and has a curved, finger receiving portion along its upper edge. The lateral sides of the liner are shorter in length than the rear wall. The liner provides an important advantage in that the crushing of cans and bottles often produce extraneous matter which adheres to the sides of the chamber. Since the liner is removable, it is a simple task to pull the liner upwards and out from the chamber in which it rests and to clean it.

Accordingly, it is a principal object of the invention to provide an apparatus for crushing cans which is convenient and easy to use.

It is another object of the invention to provide an apparatus for crushing cans, which includes safety features to insure the safety of the user.

It is a further object of the invention to provide an apparatus for crushing cans, which has a removable liner.

Still another object of the invention is to provide an apparatus for crushing cans which includes a structure for detaching crushed objects from the crush plate after crushing.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an apparatus for crushing cans, according to the present invention.

FIG. 2 is a side view of an apparatus for crushing cans, according to the invention.

FIG. 3 is an exploded view of an apparatus for crushing cans, according to the invention.

FIG. 4 is a side view of an apparatus for crushing cans, opposite to the view of FIG. 3, according to the invention.

FIG. 5 is a top view of an apparatus for crushing cans, according to the invention.

Similar reference characters denote corresponding features consistently throughout the attached drawings.

### DETAILED DESCRIPTION OF THE PREFERRED EMBODIMENTS

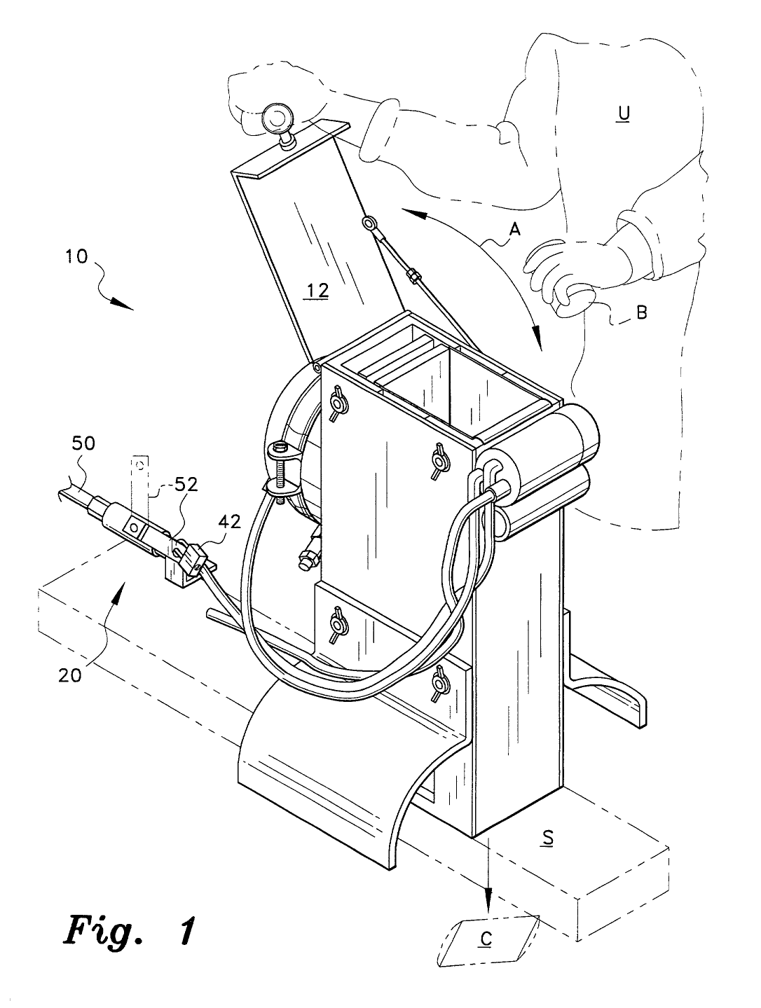

The present invention is directed to an apparatus for crushing or recycling bottles. The preferred embodiment of the present invention is depicted in FIG. 1-5, and is generally referenced by the numeral 10.

Referring now to FIG. 1, it can be seen that the apparatus for crushing cans 10 provides the user U with an easy way to compact a large number of cans, bottles, or other items, by mechanical deformation. Preferably the invention rests on an elevated, generally planar surface S, such as a table or drum, which allows crushed cans C and the like to be dropped, by gravity, into a waste or storage receptacle located thereunder. The compartment in which the cans are crushed has a bottom opening of restricted size to maintain cans in the compartment prior to crushing but which also allows cans to fall by gravity into the waste receptacle.

In FIG. 1, the user U is shown feeding pre-crushed cans B into the apparatus 10, the arrow A indicating that the lid 12 is manually closed before initiating the crushing process.

Recycling has become an increasingly important enterprise in recent years due to the large amounts of trash and waste that our society produces. Many individuals have become involved in recycling activities for both personal reasons and profit. Nevertheless, collecting recyclables can be difficult because of their bulkiness. This problem is especially associated with the collection of aluminum cans. Thus, a longfelt need exists in the art for a practical device which can be easily and safely used for compacting various recyclable, mechanically deformable articles.

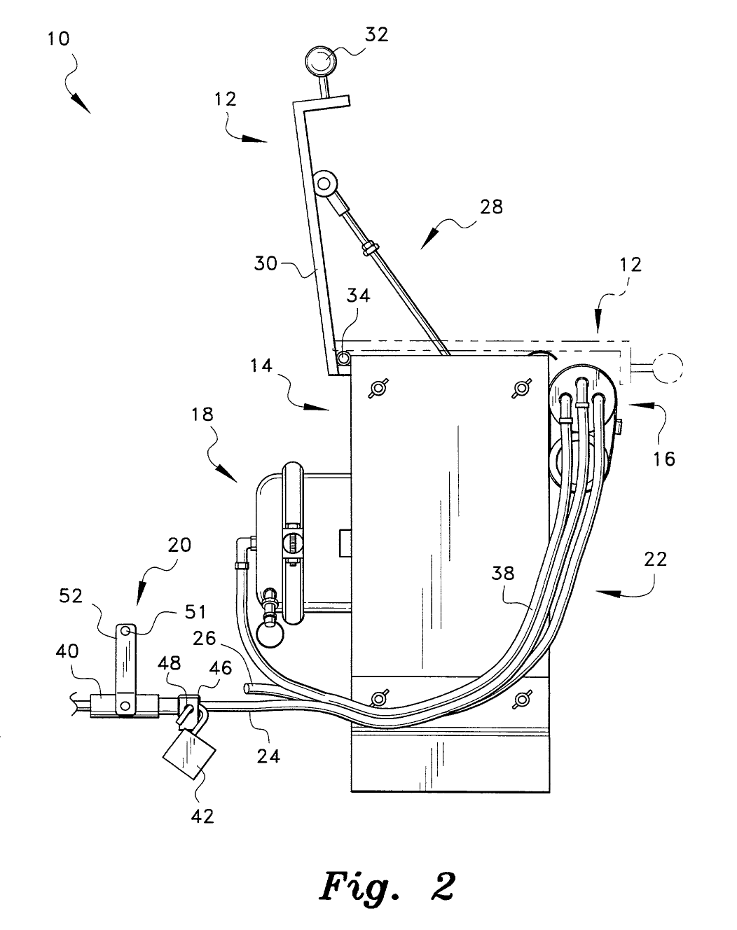

Turning now to FIG. 2, it can be seen that the apparatus for crushing cans 10, principally includes a crush chamber 14, an air control valve 16, a pneumatic air chamber 18, a key lockable air supply assembly 20, and a -plurality of air hoses, generally 22. The air control valve 16 is a conventional truck brake control valve such as commonly known in the art. Pressurized air is supplied to the air control valve 16 through an air supply hose 24. In the instant invention, the air control valve 16 is employed to control the supply of pressurized air to the pneumatic air chamber 18 when activated by closure of the lid 12 of the apparatus 10. Typically, these valves include a one-way check valve to allow for the venting of excess pressurized air through an exhaust line or tube 26, as shown. The lid 12 is connected to the air control valve 16 by a linkage 28, and the lid 12 is made up of a generally rectangular sheet 30 of metal having a knob 32 for facilitating opening. The lid 12 is hingedly attached to the crush chamber 14 by any hinge 34 conventionally known in the art, including a piano hinge.

The air control valve 16 requires that the lid 12 be in closed position (as indicated by the ghost lines at 12) in order for pressurized air to flow to the air chamber 18 to activate the apparatus 10. After the pneumatic air chamber 14 receives pressure from the air valve 16 through the air chamber hose 38, excess air is vented through the exhaust line 26. The air control valve 16 is an important safety mechanism, insuring that the apparatus 10 is never actuated when the interior of the apparatus 10 is accessible. Thus, the control valve 16 regulates the flow of the pressurized gas into the air chamber 18.

As shown in FIG. 2, the key lockable air supply assembly 20, is made up by a conventional, manually actuated air supply valve 40, the handle 52 of which may be moved from a closed position (in which the handle 52 may be securely locked by a padlock 42 or other lock to a bracket 46 attached to the support surface S) to an open position in which the handle 52 is upright. As illustrated, the arm of the padlock 42 fits through apertures, 48 and 51, disposed through the bracket 46 and the handle 52, respectively. FIG. 1 also indicates a source 50 of pressurized air such as an air compressor, connected to the apparatus 10, as well as the padlock 42 in both locked position and unlocked position (see ghost lines 52).

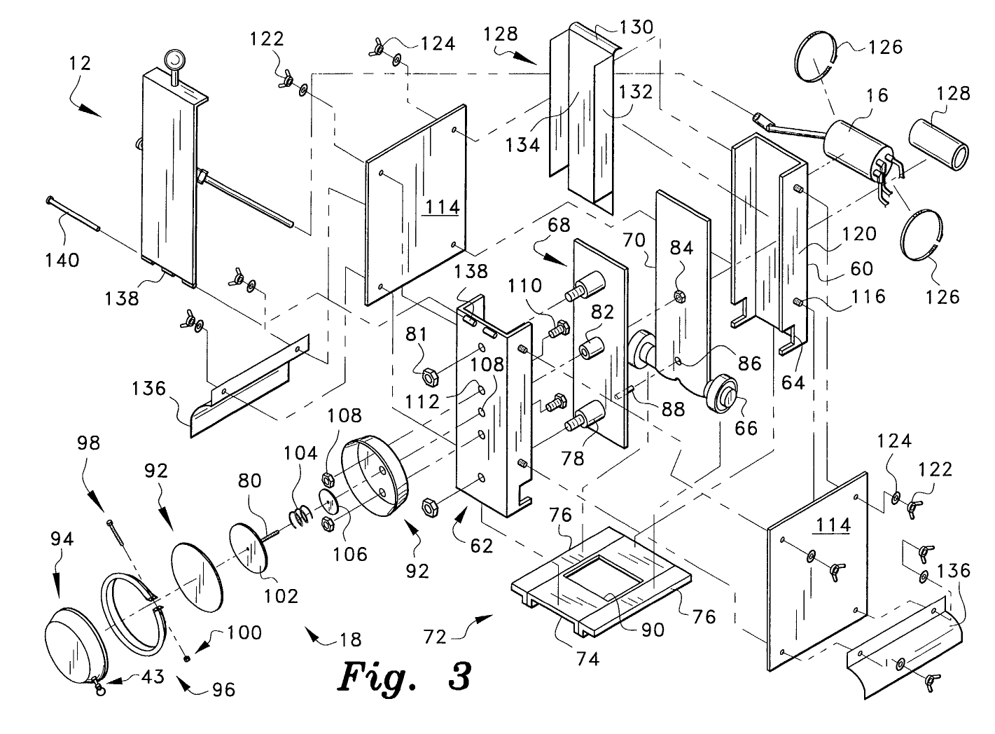

Turning now to FIG. 3, it can seen that the air crushing chamber 14 principally includes front and rear channel irons, 60 and 62, respectively, each channel iron, 60 and 62, having a generally rectangular-shaped notch, generally 64, in its side walls at their lower extent, the notches 64 dimensioned for receiving an axle and wheel 66 therethrough. The channel irons, 64 and 66, are each generally U-shaped in cross-section and are mutually oriented so as to partially enclose the interior of the apparatus 10.

The channel irons, 60 and 62, are vertically disposed, fixedly attached, and in normal relationship to an underlying, horizontally disposed, bottom structure 72, so that the two channel irons, 60 and 62, are held in spaced-apart relationship in order to define a crushing space therebetween.

The bottom structure 72 includes a horizontally disposed, bottom channel iron 74 having a generally rectangular-shaped opening 90 disposed therethrough for allowing cans which have been crushed to drop or fall from the apparatus 10 for collecting and disposal. Welded to either side of the bottom channel iron 74 are angle irons, each generally 76, the superior surfaces of which define tracks for the crush plate wheels 66. The crush plate 70 moves back and forth with respect to the front 60 and rear 62 side channel irons, the wheels 66 traveling back and forth over the angle irons 76 as the apparatus 10 is actuated. The wheels 66 are rotatably mounted to an axle welded to the bottom end of the crush plate 70.

The crushing mechanism of the invention includes an air chamber 18, guide plate 68, and crush plate 70. The guide plate 68 is a generally rectangular metallic member having a pair of spacers, each generally 78, located on the rear side thereof for holding the guide plate 68 in spaced-apart relationship to the rear channel iron 62. Structures such as bolts 81 threadably receive bolt portions extending from the spacers 78 to securely but reversibly fasten the guide plate 68 in place.

The guide plate 68 serves as a support for the air chamber piston 80 which is actuated by air pressure and is slidably movable through an aperture (not shown) centrally disposed through the guide plate 68. Collinear with the guide plate aperture 86 is a metallic tube member 82 for helping to guide the piston 80 and keep it in place. In the preferred embodiment of the invention, the end of the piston 80 is insertably received by a nut 84 fixedly attached to the central portion of the crush plate 70.

The preferably metallic crush plate 70 also has an aperture 86 disposed adjacent the mid-portion of its lower end. The aperture 86 is dimensioned for receiving a small guide pin 88 located adjacent the lower end of the plate 68, the pin 88 being normally disposed and preferably welded to its front surface. The pin 86 is reciprocally movable through the aperture 86 and helps to insure that crushed objects fall through the opening 90. The pin 86 is movably attached to the guide plate 68 and a portion of the pin is behind the crush plate 70 when in a retracted position.

When the crush plate 70 retracts backwardly, the pin 88, which is stationary and attached to the guide plate 68, is received through the crush plate aperture 86. The pin 88 pushes any objects sticking to the crush plate 70 away, to dislodge them and cause them to fall through the opening 90 in the bottom portion 72.

The pneumatic air chamber 18, which is a conventional truck brake air chamber, is pneumatically actuated and includes an exterior housing, a piston assembly, and a flexible diaphragm 92. The exterior housing includes first 92 and second 94 generally bowl-shaped, polymeric shells which together enclose the flexible diaphragm 92 and piston assembly and are held in abutting relationship by a belt 96. The diaphragm 92 is held air-tight relationship between the first 92 and second 94 shells, the belt 96 wrapping around and enclosing the flanged free edges of the first 92 and second 94 shells to hold them tightly together. The ends of the belt 96 are held together by a nut 98 and bolt 100 assembly. An air chamber relief or safety valve is shown at 43, to protect the user against high pressures in the air chamber 18. The safety valve 43 is disposed through the second shell 94.

The piston assembly includes the piston 80 and a generally circular, metallic plate 102, which is held in frictional abutment to the diaphragm 92 by a spring 104 located between the metallic plate 102 and the first housing shell 92. The piston 80 is preferably welded to the metallic plate 102 and normally and centrally disposed on the front side thereof. Air flows into the air chamber 18 through the air supply tube 24 (see FIG. 2), causing the diaphragm 92 to push against the circular plate 102, urging the piston 80 through the spring 104, and then through a polymeric spacer 106. The piston 80 passes through an aperture centrally disposed through the first shell 92 and, subsequently through an aperture 108 centrally disposed through the rear channel iron 62. The piston finally passes through the tube 82 to be received by the nut 84. The air chamber 18 is mounted through apertures 112 onto the rear channel iron 62 by a nut 108 and bolt 110 assembly. Thus, when a predetermined pressure is reached within the area defined by the diaphragm 92 and second shell 94, the piston 80 is impelled outwardly from the air chamber 18.

The crush chamber 14 defines an interior space for crushing at least one bottle or other collapsible item. In addition to the front 64 and rear 62 channel irons, this space is also determined by generally rectangular side panels 114 which are attached on either side of the apparatus 10 to channel irons 60 and 62. The side panels 114 are held in place by wing nuts, each 122, and washers, each 124. The wing nuts 122 and washers 124 are received over upstanding bolts 116 located on the outer surface of the side walls 120 of the vertical channel irons, 60 and 62. Safety baffles 136 are similarly attached by the wingnuts 122 and washers 124 to the lower two of the bolts 116 on each side of the apparatus 10. The safety baffles 136 enclose the angle irons 76, which provide the tracks for the wheels 66.

The air control valve 16 is attached to the broad, front main wall (not shown) of the front channel iron 60 by fasteners 126, which fasten the control valve 16 to a support structure 128 welded to the front main wall (not shown). The attachment of the lid 12 to the rear channel iron 62 by mating hinge elements, generally 138, and pin 140 insertably received by the hinge elements 138 when aligned, is also best shown in FIG. 3.

The crush chamber 14 includes a removable liner 128; the liner is generally U-shaped in cross-section and has a curved, finger receiving portion 130 integrally extending from its upper edge. The lateral side walls 132 of the liner 128 are shorter in length than the rear wall 134. When liquid, plastic, or metal particles are left inside the apparatus subsequent to its use, a residue buildup can occur, negatively impacting on the functioning of the apparatus 10. Since the liner 128 is removable, it becomes a simple task to pull the liner 128 upwards and out from the chamber 14 in which it rests and to clean it. The liner 128 further obviates the necessity of frequent disassembling the apparatus 10 for cleaning. This advantage is particularly significant in that drinking cans and other food or drink containing objects can carry biologically hazardous materials. The liner 128 is further advantageous in that it may be a permanent component of the apparatus 10 and is preferably metallic so it is tough and durable, in contrast to a polymeric or disposable thin film lining, which is easily torn during the crushing process.

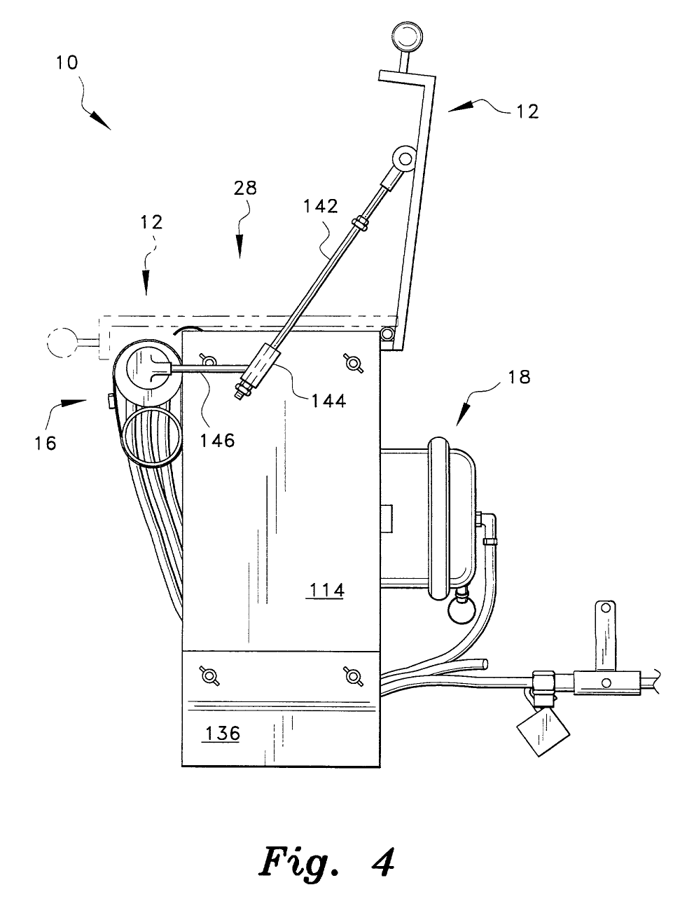

FIG. 4 shows the linkage 28 of the air control valve 16 in greater detail. The linkage 28 preferably includes a lever 142 and a rod 146 interconnected by slider sleeve mechanism 144. The lever 142 is movably mounted to the control valve 16, and the rod 146 is pivotally connected to the lid 12 by a swivel ball joint. Again, the linkage 28 allows the control valve 16 to be selectively actuated to release pressurized air into the air chamber 18 when the lid 12 is closed. Additional cans may be crushed by manually returning the lid 12 to open position.

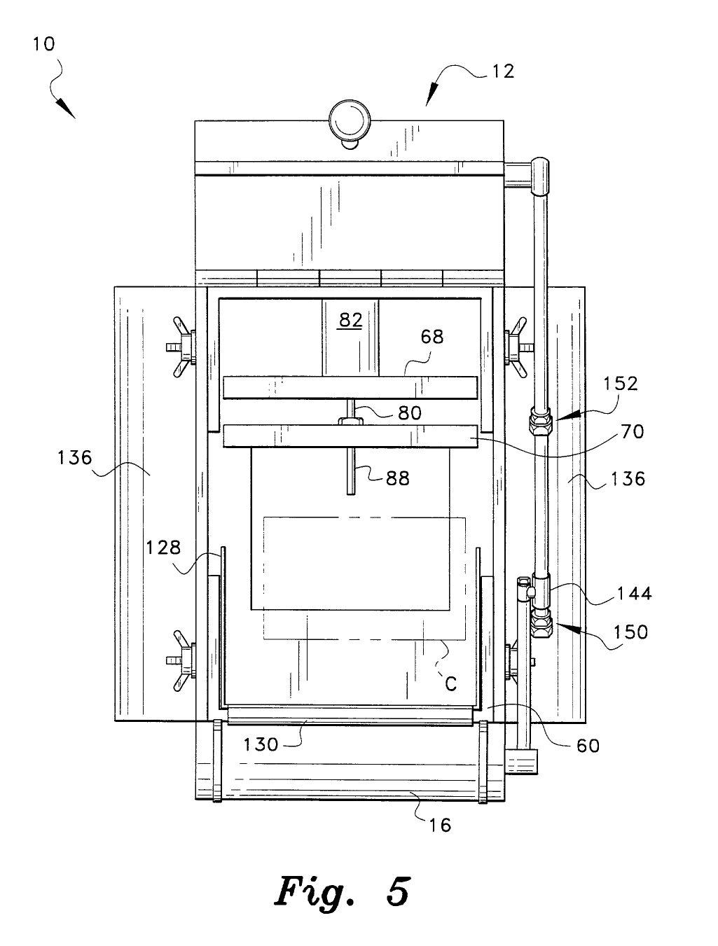

Turning to FIG. 5, it now be appreciated how the various components of the invention work together to provide a superior can and bottle crushing apparatus 10. Surface area 150 provides ample resting space for a can C (indicated in ghost lines) or bottle to rest before crushing. Crushing occurs when the crush plate 70 is forced by the piston 80, reciprocally received through the guide plate aperture (not shown) and tube member 82, towards the rear channel iron 60. The pin 88 insures that nothing adheres to the exterior surface 21 of the crush plate 70 when it returns to resting position as shown in FIG. 5. Also more clearly represented in FIG. 5 are limiting mechanisms 150 and 152. Limiting mechanism 152 preferably includes two nuts which serve as a limiter or surface of abutment for preventing the rod 142 from sliding too far into the sleeve when closing the lid 12. This advantageous feature allows the user to selectively increase or decrease the air pressure flowing into the air chamber 18. The two nuts are theadably movable along the length of the rod 142 and, when moved closer to the lid 12, allow less air to flow through the valve 16 and into the air chamber 18. When the nuts are moved closer to the sleeve 144 more air pressure is allowed to flow through the control valve 16 and into air chamber 18. Limiting mechanism 152 preferably includes two nuts theadably mounted at the end of lever 146 and serve to define a surface of abutment, whereby the rod is prevented from sliding off of the sleeve 144. Limiting mechanism 152 prevents the user from activating the control valve 16 unless the lid 12 is closed.

It is to be understood that the present invention is not limited to the embodiments described above, but encompasses any and all embodiments within the scope of the following claims.

I claim:

1. An apparatus for crushing collapsible articles comprising:
a crush plate;
a housing, the housing including a frame having a base for supporting collapsible articles, said crush plate slidably mounted to said frame;
an air chamber having a piston assembly and an air chamber housing, said piston assembly including a spring and a piston, said piston being slidably mounted in said air chamber housing and connected to said crush plate, said air chamber housing including a rigid first shell secured to said air frame and a second shell secured to said first shell, an intermediate elastic diaphragm extending between and interconnecting said shells and defining an enclosed expandable chamber for selectively receiving a pressurized gas therein, said piston assembly being mounted to said first shell and disposed between said diaphragm and said first shell whereby the receipt of pressurized gas causes said diaphragm to displace said piston from an unactuated position to an actuated position in which said crush plate is displaced to crush the collapsible article between said crush plate and said frame;
A gas control valve disposed in fluid communication with said air chamber, said control valve for controllably communicating pressurized air to said air chamber;
a lid hingedly attached to said housing to limit access to said housing; and,
a safety valve in fluid communication with said air control valve, said safety valve being configured to selectively allow gas flow into said air control valve.

2. The apparatus of claim 1, further including a rigid liner removably disposed in said housing, said liner being generally U-shaped in cross-section.

3. The apparatus of claim 1, wherein said control valve includes a linkage connecting said lid and said control valve, whereby said valve is actuated to release pressurized air into said air chamber when said lid is closed.

4. The apparatus of claim 1, wherein said control valve includes a linkage connecting said lid and said control valve, said linkage including a lever and a rod, said lever having a slider sleeve mounted thereon, said lever being connected to said control valve for actuating said control valve, said rod slidably mounted to said lever by said slider sleeve, said rod being pivotally connected to said lid by a ball joint, said linkage for allowing said air control valve to be selectively and adjustably actuated to release pressurized air into said air chamber when said lid is closed.

5. The apparatus of claim 1, wherein said air control valve includes an air exhaust tube for communicating excess pressurized air to the atmosphere.

6. The apparatus of claim 1, wherein said air control valve includes a gas conveyance line allowing for fluid communication between said safety valve and said air control valve.

7. The apparatus of claim 1, wherein said safety valve is key lockable.

8. The apparatus of claim 1, wherein said apparatus further includes a bracket and a lock, said bracket configured for mounting to a surface, said safety valve further including a handle, said lock for locking said handle to said bracket.

9. The apparatus of claim 1, further including at least one side panel, each said at least one side panel being reversibly mountable to said frame whereby said apparatus may be accessed.

10. An apparatus for crushing collapsible articles comprising:
a generally rectangular crush plate having a lower edge, said lower edge having a wheel and axle assembly attached to said lower edge, said wheel and axle assembly including a pair of wheels;
a housing defining an interior surface, the housing including a frame having a base for supporting collapsible articles, said crush plate slidably mounted to said frame, said base including a pair of tracks for said pair of wheels;
an air chamber having a piston assembly and an air chamber housing, said piston assembly including a spring and a piston, said piston being slidably mounted in said air chamber housing and connected to said crush plate, said air chamber housing including a rigid first shell secured to said air frame and a second shell secured to said first shell, an intermediate elastic diaphragm extending between and interconnecting said shells and defining an enclosed expandable chamber for selectively receiving a pressurized gas therein, said piston assembly being mounted to said first shell, said piston assembly disposed between said diaphragm and said first shell wherein the receipt of pressurized gas causes said diaphragm to displace said piston from an unactuated position to an actuated position wherein said crush plate is displaced to crush the collapsible article between said crush plate and said frame;
A gas control valve disposed in fluid communication with said air chamber, said control valve for controllably communicating pressurized air to said air chamber;
a lid hingedly attached to said housing to limit access to said housing;
a linkage connecting said gas control valve and said lid for selectively actuating said control valve when said lid is closed;
a safety valve in fluid communication with said air control valve, said safety valve being configured to selectively allow gas flow into said air control valve; and,
a rigid liner removably disposed in said housing, said liner being generally U-shaped in cross-section and for covering a portion of said interior of said housing.

11. The apparatus of claim 10, wherein said linkage connecting said lid and said control valve is selectively manually adjustable.

12. The apparatus of claim 10, wherein said linkage includes a lever and a rod, said lever having a slider sleeve mounted thereon, said lever being connected to said control valve for actuating said control valve, said rod slidably mounted to said lever by said slider sleeve, said rod being pivotally connected to said lid by a ball joint, said rod including at least one limiter for allowing said air control valve to be selectively and actuated to release a predetermined amount of pressurized air into said air chamber when said lid is closed.

13. The apparatus of claim 10, wherein said control valve includes an air exhaust tube for communicating excess pressurized air to the atmosphere.

14. The apparatus of claim 10, wherein said control valve includes a gas conveyance line allowing for fluid communication between said safety valve and said control valve.

15. The apparatus of claim 10, wherein said safety valve is key lockable.

16. The apparatus of claim 10, wherein said apparatus further includes a bracket and a lock, said bracket configured for mounting to a surface, said safety valve further including a handle, said lock for locking said handle to said bracket.

17. The apparatus of claim 10, further including at least one side panel, each said at least one side panel being reversibly mountable to said frame whereby said apparatus may be accessed.

18. The apparatus of claim 10, wherein said air chamber includes a pressure safety valve mounted to said second shell.

19. The apparatus of claim 10, wherein said liner includes a top edge, said top edge defining a curved portion dimensioned to serve as a structure for hanging said liner from said frame.

20. The apparatus of claim 10, wherein said bottom includes an opening to allow crushed cans to fall therethrough.
